(19) United States
(12) Patent Application Publication
(10) Pub. No.: US 2018/0187840 A1
(43) Pub. Date: Jul. 5, 2018

(54) PRODUCTION METHOD OF DOUBLE-WIRE STRING LIGHTS

(71) Applicant: DONGGUAN CHENGZHUO METAL PRODUCTS CO.,, Dongguan city (CN)

(72) Inventor: Jianxue Chen, Dongguan city (CN)

(73) Assignee: DONGGUAN CHENGZHUO METAL PRODUCTS CO.,, Dongguan city (CN)

(21) Appl. No.: 15/396,818

(22) Filed: Jan. 3, 2017

(30) Foreign Application Priority Data
Dec. 29, 2016 (CN) 201611248574.6

(51) Int. Cl. F21K 9/90; H01B 3/44; H01B 1/02; H01B 3/30; H01B 13/00; H01B 13/16; F21S 4/10; F21V 23/04

(52) U.S. Cl. CPC F21K 9/90; H01B 3/441; H01B 1/026; H01B 3/302; F21Y 2115/10; H01B 13/0016; H01B 13/16; F21S 4/10; F21V 23/04; H01B 3/306

(57) ABSTRACT

A production method of double-wire string lights, comprising the steps of: prepaying wires; annealing to optimize the flexibility of the wires; cooling and washing; making outer layer of the wires; removing the outer layers of both the positive and negative wires to expose the positive and negative wires and form the bulb welding positions; coating with tin; using an automatic bulb welding machine for welding of the positive wire bulb welding positions and the negative wire bulb welding positions corresponding to the positive poles and negative poles of the surface-mounted LED chips; wrapping the surface-mounted LED chips and the bulb welding positions with high-transmission epoxy resin and then putting them into a UV pre-solidification equipment with an extraman to solidify the epoxy resin in exposure to UV, demolding after solidification; the simple structure offers convenience and flexibility in use.

### BACKGROUND OF THE INVENTION

### (1) Technical Field

The present invention relates to a production method of string light, particularly to a production method of double-wire string lights.

### (2) Background Art

Flexible string lights are widely applied to decoration of buildings, bridges, arches, corridors, staircases and billboards, etc. and used as ornaments of automobiles and indoor decorative lights. The existing flexible string lights have comparatively large LED bulbs and require high level of manual operation, which is likely to cause safety hazards due to operation mistakes. Additionally, LED bulbs have a limited lighting range, failing to realize 360° illumimating. Moreover, the power cords of string lights are made of the single thick, copper wires which are likely to be broken after multiple twisting because copper has low flexibility. Meanwhile, LED bulbs need support in installation and require multiple times of welding, which is inconvenient for production and installation.

### BRIEF SUMMARY OF THE INVENTION

For solving the above-mentioned problems, the present invention provide a production method of double-wire string lights.

For achieving the purpose, the present invention adopts the following technical scheme: production method of double-wire string lights, comprising the double-wire string lights including a parallel pair of positive wire and negative wire and being coated with polytetrafluoroethene (PTFE) colloidal layer; the positive wire and the negative wire comprising a plurality of bulb welding positions evenly distributed therealong; the bulb welding position comprising a positive wire bulb welding position and a negative wire bulb welding position; the positive wire bulb welding position and the negative wire bulb welding position being respectively connected with a positive pole and a negative pole of a surface-mounted LED chip; the positive wire bulb welding position, negative wire bulb welding position and surface-mounted LED chip being wrapped by high-transmission epoxy resin colloid; the production method of double-wire string lights comprising the steps of:

(1) preparation of wires: preparing a copper alloy, checking whether a surface of a blank has any defects, such as oxidization, burrs or cracks, storing the qualified blank that are not put into processing for the moment, stretching other qualified copper alloy at the velocity of 450-550 m/min till the diameter of the copper alloy reaches 0.2-2.0 mm, putting the stretched part of wires into electrolytic tinning to produce red tinned copper wires; putting the remaining wires for electrolytic silvering to produce white silver-plated copper wires, using a fine strander to twist ultra-high-molecular-weight polyethylene (UHMWPE) core wires with the tinned copper wires in the form of spring to make a strand of positive wire of multiple copper wires, and using the fine strander to twist the UHMWPE core wires with the silver-plated copper wires in the form of spring to make a strand of negative wire of multiple copper wires;

(2) annealing: adopting the current of 22-28 ampere (A), the voltage of 25-27 V and the velocity of 22 m/min to send the positive and negative wires through Step (1) into an annealing furnace; wherein the annealing furnace having an upper layer is at 570° C. and a lower layer is at 580° C.;

(3) cooling and washing: cooling and washing the positive and negative wires after Step (2), and drying the positive and negative wires till no residual liquid adheres to the surfaces thereof;

(4) preparation of outer layer of the wires: soaking the positive and negative wires after Step (3) in the PTFE colloid till an PTFE colloidal layer is formed on surfaces of the tinned copper wires as well as the silver-plated copper wires;

(5) coiling the positive wires in parallel with the negative wires around a stick mold and removing the outer layers of both, the positive and negative wires at the spacing of 10-20 cm to expose the positive and negative wires and form the bulb welding positions;

(6) coating with tin, stirring solder paste after annealing, applying the solder paste to surfaces of the bulb welding positions;

(7) using an automatic bulb welding machine for welding of the positive wire bulb welding positions and the negative wire bulb welding positions corresponding to the positive poles and negative poles of the surface-mounted LED chips; wrapping the surface-mounted LED chips and the bulb welding positions with high-transmission epoxy resin and then putting them into a UV pre-solidification equipment with an extraman to solidify the epoxy resin in exposure to UV, demolding after solidification;

Particularly, the high-transmission epoxy resin consists of component A and component B with component A comprising of 60-80% epoxy resin, 19-39% low-viscosity modified epoxy resin, 0.1-0.5% anti-foaming agent and 0.1-0.5% flatting agent and component B comprising of 64-99% amine curing agent, 0-20% curing agent promoter, 0-15% modifier, 0.2-0.5% antioxidant and 0.2-0.5% ultraviolet absorber.

(8) finished product inspection: checking whether there is poor welding, solder splashes or short circuits by visual inspection and then conducting electrical examination to test the electrical performance and parameters of the products;

(9) packaging: packaging up the wires with anti-static and moisture-proof packages.

More preferably, wherein the outer layer of the wires in Step (4) is applied with insulating varnish and paint film curing; wherein the insulating varnish, comprises polyimide×1, nano-silica×2.5, mica powder×3, antioxidant×1,5, 1,2-Bis(pentabromophenyl) ethane (BPBPE)×1.5, organic silicone oil×1.5, glycerine×3, zinc naphthenate×3, carbon black×3, organic silicone×1L wood oil×11, solvent gasoline 200×11, poiyurethane insulating varnish×19, and high-temperature color concentrate×28.

More preferably, wherein the surfaces of the tinned copper wires and silver-plated copper wires in Step (1) are respectively wrapped by one of the following layer: PVC PE, PP, PA.

More preferably, wherein the surfaces of the tinned copper wires and silver-plated copper wires in Step (1) are respectively wrapped by one of the following layer: TPU, TPE.

More preferably, wherein the string lights further comprise a controller; wherein the controller comprises a power supply circuit in successive connection based on electrical properties, a micro-processor, a switch control circuit and a wireless communications circuit; wherein the wireless communications circuit: comprises a remote controller or a mobile APP, and the switch control circuit comprises a controllable silicon switch.

The present invention has following advantages:

1. The copper alloy wires in the present invention contain Mg and Si, which significantly improves the rigidity of the copper alloy wires and avoids the adverse effects on the conductivity of the copper alloy wires due to addition of Fe, Cu, Zn, Zr, Sc, Cr, Ti, Mn, etc. so that the copper alloy wires has high rigidity as well as high conductivity. Additionally, the UHMWPE core wires are stranded with the tinned copper wires in the form of spring, offering mild retraction and improving the flexibility of wires resistant to tension and twisting. Moreover, the present invention can be bent optionally and installed anywhere according to customer demands;

2. In the present invention, the in-line bulbs of the existing string lights that require manual operation and installation are replaced by the surface-mounted LED bulbs of Model 0603, 2835 or 5050, offering flexible ribbon light source in 16 million different sharp colors and having the long service life of 25,000 hours. The power of the surface-mounted LED bulb 5050 is 0.2 W, the power of the surface-mounted LED bulb 2835 is 0.06 W and the power of the surface-mounted LED bulb 0603 is 0.1 W. In respect of electrical power, the surface mounted LED bulbs outperform, the in-line LED bulbs in energy saving.

3. The surface-mounted LED chips are adopted in the present invention. With the high-transmission epoxy resin colloid, the surface-mounted LED bulbs on the bulb welding positions enable 360° illumination. The surface-mounted LED bulbs are directly welded onto the parallel wires, which realize electric connection between surface-mounted LED bulbs without secondary processing of electric circuit welding. It is easy to install;

4. The present invention can be linked to a mobile APP for remote control to independently design any special atmosphere or change between scenarios.

5. The double-sided tape is adopted in the present invention for lossless installation.

### BRIEF DESCRIPTION OF THE SEVERAL VIEWS OF THE DRAWING(S)

FIG. 1 is a schematic view of the present invention;

FIG. 1A is a partial enlarged schematic view of part A in FIG. 1.

### DETAILED DESCRIPTION OF THE INVENTION

The embodiments of the invention is described in details with reference to the drawings hereinafter.

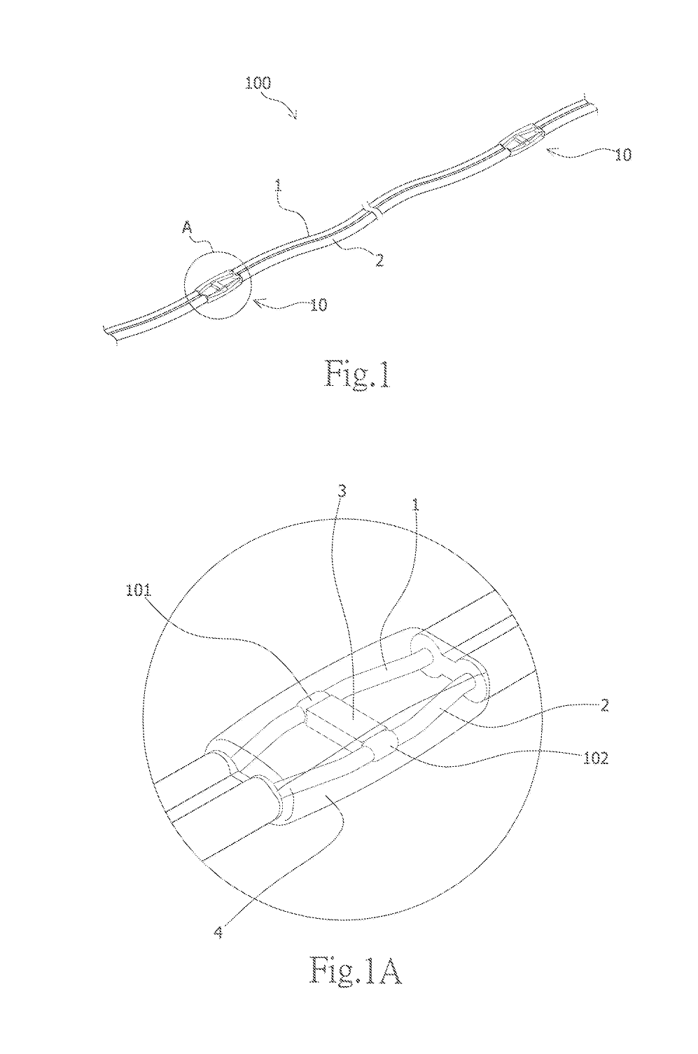

The present invention relates to a production, method of double-wire string lights. As shown in FIG. 1 and FIG. 1A, the double-wire string lights (100) comprise a parallel pair of positive wire (1) and negative wire (2). The positive wire (1) and negative wire (2) are coated with polytetrafluoroethene (PTFE) colloidal layer. The positive wire (1) and the negative wire (2) comprise a plurality of bulb welding positions (10) evenly distributed therealong. The bulb welding position (10) comprises a positive wire bulb welding position (101) and a negative wire bulb welding position (102). The positive wire bulb welding position (101) and the negative wire bulb welding position (102) are respectively connected with a positive pole and a negative pole of a surface-mounted LED chip (3). The positive wire bulb welding position (101), negative wire bulb welding position (102) and surface-mounted LED chip (3) are wrapped by the high-transmission epoxy resin colloid (4). The positive wire (1) and the negative wire (2) have two structures, including structure 1: both the positive wire and the negative wire are copper wires, in which case, the positive wire is usually a copper wire (in red) or a silver-plated copper wire and the negative wire is usually a tinned copper wire or a silver-plated copper wire (in white); structure 2: the positive wire consists of two strands of stranded copper wires, which is usually the “3+4+1” positive wire with “3” standing for three stranded copper wires, “4” for four copper wires (in red) and “1” for one 250D nylon wire while the negative wire also consists of two strands of stranded copper wires, which is usually the “7+1” negative wire with “7” standing for seven tinned copper wires (in white) and “1” for one 250D nylon wire. The diameters of the positive and negative wires of the first structure vary from 0.20-1.00 mm while the diameters of the positive and negative wires of the second structure range from 0.08-0.30 mm.

The present invention relates to a production method of double-wire string lights with the positive wire and the negative wire adopting the first structure. The production method complies the following steps:

Step 1: Preparation of wires: Prepare copper alloy, check whether the surface of the blank has any defects, such as oxidization, burrs or cracks, store the qualified blank that are not put into processing for the moment, stretch, other qualified copper alloy at the velocity of 450-550 m/min till the diameter of the copper alloy reaches 0.2-2.0 mm, put the stretched part of wires into electrolytic tinning to produce the red tinned copper wires; put the remaining wires for electrolytic silvering to produce the white silver-plated copper wires, use a fine strander to twist ultra-high-molecular-weight polyethylene (UHMWPE) core wires with the tinned copper wires in the form of spring to make a strand of positive wire of multiple copper wires and use the fine strander to twist the UHMWPE core wires with the silver-plated copper wires in the form of spring to make a strand of negative wire of multiple copper wires; using the UHMWPE core wires to form strands of wires can dramatically improve the flexibility of wires, effectively improve the quality of wires to prevent tension or twisting fracture, extend the service life of wires; the wires of mild retraction effectively solve the problem of fracture of flexible string lights due to multiple twisting as well as the problem of low flexibility;

Step 2: Annealing: Adopt the current of 22-28 ampere (A), the voltage of 25-27 V and the velocity of 22 m/min to send the positive and negative wires through Step 1 into an annealing furnace. The annealing furnace having an upper layer is at 570° C. and having a lower layer is at 580° C. Step 2 is designed to optimize the flexibility of the wires;

Step 3: Cooling and washing: Cool and wash the positive and negative wires after Step 2 and dry the wires till no residual liquid adheres to the surfaces of wires;

Step 4: Preparation of outer layer of the wires: Soak, the positive and negative wires after Step 3 in the epoxy resin colloid till an PTFE colloidal layer is formed on surfaces of the tinned copper wires as well as the silver-plated copper wires. The PTFE colloidal layer is resistant to high temperature up to 200° C. and low temperature up to −60° C. The PTFE colloidal layer is of the rigidity of 65 P and the fire resistance of V-0 and it is ultraviolet ray resistant and waterproof.

Step 5: Coil the positive wires in parallel with the negative wires around a stick mold and remove the outer layers of both the positive and negative wires at the spacing of 10-20 cm to expose the positive and negative wires and form the bulb welding positions.

Step 6: Stir solder paste after annealing, apply the solder paste to the surfaces of the bulb welding positions; pay attention to the temperature to avoid cold welding because the temperature is too low to melt the solder paste or foaming of the FPC due to high temperature; ensure the appropriate temperature, low temperature may cause low volatility of flux and residue in annealing, adversely affecting the appearance while high temperature may cause early volatility of flux and faulty soldering in annealing or even form solder splashes;

Step 7: Use the automatic bulb welding machine (also known as surface mounting machine or bulb installation machine) for welding of the positive wire bulb welding positions and the negative wire bulb welding positions corresponding to the positive poles and negative poles of the surface-mounted LED chips. The model of the surface-mounted LED chips is one of Model 0603, 2835 or 5050; wrap the surface-mounted LED chips and the bulb welding positions with high-transmission epoxy resin and then put them into a UV pre-solidification equipment with an extraman to solidify the epoxy resin in exposure to UV. Demold after solidification. Since the cooper enamel wires are coiled integrally in the mold, a complete LED string is available after demolding upon completion of finished product. The production process is simple and easy, which avoids the complicated secondary processing in the traditional production method of LED strings. In addition, the simple structure offers convenience and flexibility in use.

Particularly, the high-transmission epoxy resin consists of component A and component B with component A comprising of 60-80% epoxy resin, 19-39% low-viscosity modified epoxy resin, 0.1-0.5% anti-foaming agent and 0.1-0.5% flatting agent and component B comprising of 64-99% amine curing agent, 0-20% curing agent promoter, 0-15% modifier, 0.2-0.5% antioxidant and 0.2-0.5% ultraviolet absorber.

Step 10: Finished product inspection: Check whether there is poor welding, solder splashes or short circuits by visual inspection and then conduct electrical examination to test the electrical performance and parameters of the products;

Step 11: Packaging: Package up the wires with anti-static and moisture-proof packages in 5 meter as a coil.

Preferably, insulating varnish and paint film may be applied to the solidification, of outer layer of wires; the insulating varnish comprises of polyimide×1, nano-silica×2,5, mica powder×3, antioxidant×1.5, 1,2-Bis(pentabromophenyl) ethane (BPBPE)×1,5, organic silicone oil×1.5, glycerine×3, zinc naphthenate×3, carbon black×3, organic silicone×11, wood oil×11, solvent gasoline 200×11, polyurethane insulating varnish×19 and high-temperature color concentrate×28. The insulating varnish, in different colors are prepared by the polyurethane insulating varnish and high-temperature color concentrate with different proportion. Through the baking varnish technique, the string lights in any colors are available and these string lights, in addition to the sharp colors, are UV-resistant and high-temperature resistant to prevent melting due to high temperature. In addition, with the excellent acid and base resistance and weathering resistance, these string lights have stable colors and will not discolor easily.

Preferably, to improve the resistance to abrasion of the string lights, the surfaces of the tinned copper wires and silver-plated copper wires are respectively wrapped by the PVC or PE or PP or PA layer with the PVC resistant to the high temperature up to 105° C., having the rigidity of up to 50 P, the flame retardance of VW-1, resistant to UV and waterproof and the PE, PP and PA resistant to the high, temperature up to 150° C., among which PA shows excellent resistance to abrasion.

Preferably, to improve the thermoplasticity of the string lights, the outer layers of the tinned copper wires and silver-plated copper wires are respectively wrapped by the TPU or TPE layers.

Preferably, the string lights also comprise a controller. The controller consists of a power supply circuit in successive connection based on electrical properties, a micro-processor, a switch control circuit and a wireless communications circuit. The described wireless communications circuit comprises of a remote controller or a mobile APP while the described switch control circuit comprises of a controllable silicon switch connected to the positive and negative wires that enables switching on and off the string lights by touching the keys and change the colors by long press key.

The present invention has the following advantages:

1. The copper alloy wires in the present invention contain Mg and Si, which significantly improves the rigidity of the copper alloy wires and avoids the adverse effects on the conductivity of the copper alloy wires due to addition of Fe, cu, Zn, Zr, Se, Cr, Ti, Mn, etc. so that the copper alloy wires has high rigidity as well as high conductivity. Additionally, the UHMWPE core wires are stranded with the tinned copper wires in the form of spring, offering mild retraction and improving the flexibility of wires resistant to tension and twisting. Moreover, the present invention can be bent optionally and installed anywhere according to customer demands;

2. In the present invention, the in-line bulbs of the existing string lights that require manual operation and installation are replaced by the surface-mounted LED bulbs of Model 0603, 2835 or 5050, offering flexible ribbon light source in 16 million different sharp colors and having the long service life of 25,000 hours. The power of the surface-mounted LED bulb 5050 is 0.2 W, the power of the surface-mounted LED bulb 2835 is 0.06 W and the power of the surface-mounted LED bulb 0603 is 0.1 W. In respect of electrical power, the surface mounted LED bulbs outperform the in-line LED bulbs in energy saving.

3. The surface-mounted LED chips are adopted in the present invention. With the high-transmission, epoxy resin colloid, the surface-mounted LED bulbs on the bulb welding positions enable 360° illumination. The surface-mounted LED bulbs are directly welded onto the parallel wires, which realize electric connection between surface-mounted LED bulbs without secondary processing of electric circuit welding. It is easy to install;

4. The present invention can be linked to a mobile APP for remote control to independently design any special atmosphere or change between scenarios.

5. The double-sided tape is adopted in the present invention for lossless installation.

6. Different light effects are corresponding to the electric wires in different colors of excellent transmittancy and thus the strings lights are applicable to decoration of Christmas trees, iron art works or outdoor celebrations.

The above only describes some exemplary embodiments of the present invention. Those having ordinary skills in the art may also make many modifications and improvements without departing from the conception of the invention, which shall all fall within the protection scope of the invention.

I claim

1. A production method of double-wire string lights, comprising the double-wire string lights (100) including a parallel pair of positive wire (1) and negative wire (2) and being coated with polytetrafluoroethene (PTFE) colloidal layer; the positive wire (1) and the negative wire (2) comprising a plurality of bulb welding positions (10) evenly distributed therealong; the bulb welding position (10) comprising a positive wire bulb welding position (101) and a negative wire bulb welding position (102); the positive wire bulb welding position (101) and the negative wire bulb welding position (102) being respectively connected with a positive pole and a negative pole of a surface-mounted LED chip (3); the positive wire bulb welding position (101), negative wire bulb welding position (102) and surface-mounted LED chip (3) being wrapped by high-transmission epoxy resin colloid (4); the production method of double-wire string lights comprising the steps of:
(1) preparation of wires: preparing a copper alloy, checking whether a surface of a blank has any defects, such as oxidization, burrs or cracks, storing the qualified blank that are not put into processing for the moment, stretching other qualified copper alloy at the velocity of 450-550 m/min till the diameter of the copper alloy reaches 0.2-2.0 mm, putting the stretched part of wires into electrolytic tinning to produce red tinned copper wires; putting the remaining wires for electrolytic silvering to produce white silver-plated copper wires, using a fine strander to twist ultra-high-molecular-weight polyethylene (UHMWPE) core wires with the tinned copper wires in the form of spring to make a strand of positive wire of multiple copper wires, and using the fine strander to twist the UHMWPE core wires with the silver-plated copper wires in the form of spring to make a strand of negative wire of multiple copper wires;
(2) annealing: adopting the current of 22-28 ampere (A), the voltage of 25-27 V and the velocity of 22 m/min to send the positive and negative wires through Step (1) into an annealing furnace; wherein the annealing furnace having an upper layer is at 570° C. and a lower layer is at 580° C.;
(3) cooling and washing: cooling and washing the positive and negative wires after Step (2), and drying the positive and negative wires till no residual liquid adheres to the surfaces thereof;
(4) preparation of outer layer of the wires: soaking the positive and negative wires after Step (3) in the PTFE colloid till an FIFE colloidal layer is formed on surfaces of the tinned copper wires as well as the silver-plated copper wires;
(5) coiling the positive wires in parallel with the negative wires around a stick mold and removing the outer layers of both the positive and negative wires at the spacing of 10-20 cm to expose the positive and negative wires and form the bulb welding positions;
(6) coating with tin, stirring solder paste after annealing, applying the solder paste to surfaces of the bulb welding positions;
(7) using an automatic bulb welding machine for welding of the positive wire bulb welding positions and the negative wire bulb welding positions corresponding to the positive poles and negative poles of the surface-mounted LED chips; wrapping the surface-mounted LED chips and the bulb welding positions with high-transmission epoxy resin and then putting them into a UV pre-solidification equipment with an extraman to solidify the epoxy resin in exposure to UV, demolding after solidification;
(8) finished product inspection; checking whether there is poor welding, solder splashes or short circuits by visual inspection and then conducting electrical examination to test the electrical performance and parameters of the products;
(9) packaging: packaging up the wires with anti-static and moisture-proof packages.

2. The production method of double-wire string lights according to claim 1, wherein the outer layer of the wires in Step (4) is applied, with insulating varnish and paint film curing; wherein the insulating varnish comprises polyimide×1, nano-silica×2,5, mica powder×3, antioxidant×1.5, 1,2-Bis(pentabromophenyl) ethane (BPBPE)×1,5, organic silicone oil×1,5, glycerine×3, zinc naphthenate×3, carbon black×3, organic silicone x 11, wood oil×11, solvent gasoline 200×11, polyurethane insulating varnish×19, and high-temperature color concentrate×28.

3. The production method of double-wire string lights according to claim 1, wherein the surfaces of the tinned copper wires and silver-plated copper wires in Step (1) are respectively wrapped by one of the following layer: PVC PE, PP, PA.

4. The production method of double-wire string lights according to claim 1, wherein the surfaces of the tinned copper wires and silver-plated copper wires in Step (1) are respectively wrapped by one of the following layer: TPU, TPE.

5. The production method of double-wire string lights according to claim 1, wherein the string lights further comprise a controller;
wherein the controller comprises a power supply circuit in successive connection based on electrical properties, a micro-processor, a switch control circuit and a wireless communications circuit;
wherein the wireless communications circuit comprises a remote-controller or a mobile APP, and the switch control circuit comprises a controllable silicon switch.
